(19) United States
(12) Patent Application Publication
(10) Pub. No.: US 2024/0294148 A1
(43) Pub. Date: Sep. 5, 2024

(54) Method for Controlling a Motor Vehicle, Electronic Computing Apparatus and Motor Vehicle

(71) Applicant: Volkswagen Aktiengesellschaft, Wolfsburg (DE)

(72) Inventors: Arne Bartels, Wolfsburg (DE); Clemens Markus Hruschka, Dresden (DE); Jochen Hesse, Schwülper (DE)

(73) Assignee: Volkswagen Aktiengesellschaft, Wolfsburg (DE)

(21) Appl. No.: 18/592,893

(22) Filed: Mar. 1, 2024

(30) Foreign Application Priority Data
Mar. 2, 2023 (DE) 10 2023 201 885.3

(51) Int. Cl. B60T 7/22; B60Q 9/00; G06V 20/58

(52) U.S. Cl. CPC B60T 7/22; B60Q 9/00; G06V 20/58; G06V 2201/08

(57) ABSTRACT

The disclosure relates to a method for controlling a motor vehicle by means of a driver assistance function, wherein in an environment of the motor vehicle, an object is determined which is classified as a school bus, wherein a confidence value for this classification is determined, and an action of the motor vehicle associated with the determined confidence value is triggered, wherein the action is selected in dependence on the country in which the motor vehicle is located.

### CROSS-REFERENCE TO RELATED APPLICATIONS

This application claims priority to German Patent Application No. DE 10 2023 201 885.3, filed on Mar. 2, 2023 with the German Patent and Trademark Office. The contents of the aforesaid patent application are incorporated herein for all purposes

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

The disclosure relates to a method for controlling a motor vehicle by means of a driver assistance function, an electronic computing apparatus, and a motor vehicle with an electronic computing apparatus.

In road traffic, special consideration must be given to buses. One challenge can be reliable classification of stopping vehicles in respect of whether the stopping vehicle is a bus or a school bus and not a normal vehicle.

### SUMMARY

A need exists for a solution that enables reliable identification of a school bus and an appropriate response of a driver assistance system to the determined school bus.

The need is addressed by the subject matter of the independent claim(s). Embodiments of the invention are described in the dependent claims, the following description, and the drawings.

### BRIEF DESCRIPTION OF THE DRAWINGS

FIG. 1 shows a method diagram for a method for controlling a motor vehicle by means of a driver assistance function;

FIG. 2 shows a plan view of a first traffic situation;

FIG. 3 shows a plan view of a second traffic situation; and

FIG. 4 shows a table for determining a confidence value for the classification of an object as a school bus.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

Features, benefits, and possible embodiments presented in the scope of the description for one of the subject matters of the independent claims are to be regarded at least analogously as features, benefits, and possible embodiments of the respective object of the other independent claims and each possible combination of the objects of the independent claims, in conjunction with one or more of the dependent claims, as the case may be.

The disclosure relates to a method for controlling a motor vehicle by means of a driver assistance function. The driver assistance function can be configured, in particular, to assist a driver of the motor vehicle in guiding the motor vehicle. For example, the driver assistance function is configured to take over a longitudinal guidance and/or transverse guidance of the motor vehicle.

In some embodiments, it is provided that within an environment of the motor vehicle, an object is determined which is classified as a school bus, wherein a confidence value for this classification is determined. In other words, environmental data characterizing the environment of the motor vehicle is recorded by means of a detection apparatus. Based on this environmental data, the object arranged in the environment of the motor vehicle is discovered and classified. Classification of the object is to be understood to mean that the object is categorized as a school bus or not a school bus. In this context, the confidence value specifies the probability with which the object classified as a school bus is actually a school bus. The higher the confidence value, the higher the probability that the object classified as a school bus is actually a school bus, and this is not an incorrect classification of the object as a school bus.

In some embodiments, by means of the driver assistance function, an action of the motor vehicle associated with the determined confidence value is triggered, wherein the action is selected in dependence of a country in which the motor vehicle is located. In other words, depending on how certain the system is that the object classified as a school bus is actually a school bus, a corresponding action of the motor vehicle is triggered by the driver assistance system. This means that with a higher determined confidence value, a first action of the motor vehicle can be triggered and with a second, comparatively lower confidence value, a second action of the motor vehicle that is different compared to the first action can be triggered. In this way, the respective triggered action can take into account that the lower the confidence value is, it may be the case that the object has been incorrectly classified as a school bus. In particular, it is provided that with a lower determined confidence value, less significant interventions are made in a control of the motor vehicle by means of the driver assistance system than with a high determined confidence value. Thus, with the low determined confidence value, the responsibility for controlling the motor vehicle rests more in the hands of the driver than would be the case with a high confidence value. Due to the fact that the action is selected in dependence on the country in which the motor vehicle is located, the action triggered by means of the driver assistance function can be especially well adapted to the respective regionally required road traffic regulations. In other words, it is determined in the method what country the motor vehicle is located in. It can be additionally determined what traffic rules apply with respect to interaction with school buses in the country in which the motor vehicle is located. By selecting the action in dependence on the country in which the motor vehicle is located, it can be ensured that respective country-specific requirements for interaction with school buses can be complied with while the driver is being assisted in controlling the motor vehicle by means of the driver assistance function. The method is thus suitable for use in different countries, in particular those countries for which respective possible actions of the motor vehicle for interaction with school buses are stored.

In some embodiments, it is provided that it is determined what lanes the object classified as a school bus, and the motor vehicle, are located in and the triggering of the action is omitted if it is determined that compared to a first lane in which the object classified as a school bus is located, the motor vehicle is located in a second lane structurally separated from the first lane. Thus, if the vehicle is located in the second lane, which is structurally separated from the first lane in which the object classified as a school bus is located, then the triggering of the action of the motor vehicle provided for as a response to school buses is omitted by the driver assistance function. The first lane and the second lane can be, in particular, opposite-travel lanes whose travel directions are oriented opposite relative to one another. If the first lane and the second lane are structurally separated from one another, it can be presumed that the motor vehicle poses no, or merely a particularly low, danger to respective vehicle occupants or potential vehicle occupants of the object classified as a school bus. The triggering of the action of the motor vehicle representing the response to the school bus can thus be omitted by the driver assistance function. The motor vehicle can thus continue to drive in the second lane, unaffected by the object classified as a school bus.

In some embodiments, it is provided that, as action, the motor vehicle is decelerated by means of the driver assistance function, in particular is automatically braked to a standstill at a preset relative position to the object. Alternatively or additionally, as an action, an indicator signal characterizing the determined object classified as a school bus can be output in the interior of the motor vehicle. By decelerating the motor vehicle, the motor vehicle is slowed down, by which a danger of a collision of the motor vehicle with persons exiting the object classified as a school bus, or, respectively, persons moving toward the object classified as a school bus can be kept particularly low. A danger of an accident can thus be kept particularly low. By decelerating the motor vehicle in turn, a braking path of the motor vehicle is shortened, such that the motor vehicle can be braked particularly rapidly and with a particularly short braking path, if it was to be determined that a person is walking in the travel direction in front of the motor vehicle. A danger of persons walking in the lane can be particularly high in the environment of school buses since respective persons who have exited the school bus could cross a road or respective persons who want to board the school bus could cross the road. By outputting the indicator signal in the interior of the motor vehicle, the driver of the motor vehicle can be made aware of the object classified as a school bus especially well. Due to the fact that the driver is made aware of the object classified as a school bus by means of the indicator signal, the driver can consider especially well respective persons crossing the lane in which the motor vehicle is located to reach the school bus or move away from the school bus.

In this connection, it can be provided in an embodiment that if while the motor vehicle is being decelerated by means of the driver assistance function it is determined that a brake pedal of the motor vehicle has been actuated, the motor vehicle is automatically braked to a standstill by means of the driver assistance function. In other words, as action, the motor vehicle is merely decelerated by means of the driver assistance function in response to the object classified as a school bus, that means is not decelerated completely until a standstill, but rather merely slowed down, and is only braked to a standstill once it has been determined that the driver has actuated the brake pedal. If it is determined that the driver actuated the brake pedal, then it is established that the driver sees a necessity in decelerating the vehicle, for example because the driver has also classified the object as a school bus. Consequently, the motor vehicle is braked to a stop by means of the driver assistance system, such that the motor vehicle comes to a standstill at a preset relative position to the object. For example, as action, it can be provided that with a determined first confidence value, the motor vehicle is braked until standstill by means of the driver assistance function. With a determined second confidence value that is smaller than the first confidence value, as action, the motor vehicle can be braked by means of the driver assistance function, without the motor vehicle being completely stopped, wherein the motor vehicle is braked to standstill by means of the driver assistance function if after or during the decelerating of the motor vehicle by means of the driver assistance function it is established that the driver has actuated the brake pedal.

In some embodiments, it is provided that the object is determined and classified through image processing based on camera data detected by means of a detection apparatus of the motor vehicle. This means that the detection apparatus of the motor vehicle comprises at least one camera apparatus, which with its detection range is directed at the environment of the motor vehicle. In this way, images showing the environment of the motor vehicle are recorded as camera data by means of the camera apparatus. These images can be analyzed by means of image processing, by which the presence of the object can be determined based on the camera data. Furthermore, the object can be classified based on the camera data. This means that based on the camera data, it can be determined what the object is, in particular if the object is a school bus or not. Based on the camera data, particularly extensive information about the object can be obtained, by which the object can be classified with a particularly high confidence value.

In some embodiments, it is provided that the object is classified as a school bus if it is established that the object has at least a preset minimum size and/or the object is stopped at a passenger wait-area and/or a stop sign is arranged on the object and/or multiple pedestrians are arranged at the lane edge within a preset maximum distance to the object and/or a warning blinker of the object is activated. The more of the mentioned circumstances are established as present, the higher the confidence value for classifying the object as a school bus. If the object has at least the preset minimum size, then it can be established that the object is a large vehicle, such as a bus. If it is established that the object is stopping within a preset radius of a passenger wait-area, then it is established that the object is stopping at the passenger wait-area. The passenger wait-area can be determined based on a determined passenger wait-area sign and/or based on passenger wait-area positions stored in respective map data. Whether a stop sign is arranged on the object can be determined, for example, by image processing based on the camera data. If it is determined that the object is stopping and more persons than a preset minimum number of persons are arranged in the lane in which the object is stopped, within the preset maximum distance to the object, then it is established that the persons are waiting for the object. Consequently, it is presumed that the object is a school bus. It can be determined that the warning blinker of the object is activated based on, for example, the detected camera data. Thus, based on the camera data, it can be investigated whether the object has respective warning lights and whether these warning lights of the object are blinking. Whether the warning lights of the object are blinking can be determined in particular based on a chronological sequence of multiple images recorded by means of the detection apparatus, which images respectively show the object. Based on the presence of the mentioned circumstances, the object can be particularly clearly classified as a school bus or not as a school bus.

In this connection and in some embodiments, the more of the circumstances are established as present, the higher the confidence value is determined. In other words, if the confidence value signifying that the object is a school bus is higher, more indicators indicate that the object is a school bus. Thus, within the scope of the method, depending on the determined circumstances, it can be determined with a particularly high or a particularly low confidence value that the object is a school bus. When particularly few of the mentioned circumstances are present, a particularly low confidence value can be determined, such that it is determined that it is most probable that the object is not a school bus. The danger of incorrectly establishing that the object is a school bus can thus be kept particularly low.

In some embodiments, it is provided that the circumstances are differently weighted with regard to their influence on the determination of the confidence value. This means, for example, that the determination that the object has at least a preset minimum size exerts a greater influence on the determined confidence value than if it is established that a warning blinker of the object is activated. A higher confidence value that the object is actually a school bus can thus be achieved when, although merely few of the mentioned circumstances are present, the present circumstances are nevertheless those circumstances that have a particularly high weight with regard to their influence on the confidence value. This different weighting of the circumstances makes it possible for respective error probabilities of the circumstances to be taken into account when determining the confidence value. In this context, the respective error probabilities of the circumstances describe how probable it is that the object is not a school bus despite the respective circumstance having been determined to be present. For example, the error probability that the object is incorrectly classified as a school bus is lower when it is established as a circumstance that the object has at least the preset minimum size, since by this all objects, in particular all traffic participants, in particular all motor vehicles, that are smaller than the preset minimum size are excluded than when merely the circumstance that the warning blinker of the object is activated is present, since all motor vehicles have a warning blinker. By weighting the respective circumstances, the determined confidence value with regard to the classification of the object as a school bus illustrates particularly well how probable it is that the object is actually a school bus.

The teachings herein relate further to an electronic computing apparatus that is configured to control a driver assistance function as is described herein. This means that the electronic computing apparatus is configured for determining an object within an environment of the motor vehicle and for classifying the object as a school bus and for determining a confidence value for this classification. Furthermore, the electronic computing apparatus is configured for controlling the driver assistance function such that this triggers an action of the motor vehicle associated with the determined confidence value. In this context, the electronic computing apparatus is configured, in particular, to select the action in dependence on the country in which the motor vehicle is located. The electronic computing apparatus can be configured for determining the country the motor vehicle is located in, based on a position of the motor vehicle.

The teachings herein relate further to a motor vehicle having an electronic computing apparatus as already described in connection with the electronic computing apparatus.

Other features are apparent from the following description of the FIGS. with reference to the FIGS. The features and combinations of features mentioned in the preceding, as well as the features and combinations of features presented in the following in the description of the FIGS. and/or just in the FIGS., can be used not only in the mentioned combination, but also in other combinations or by themselves without departing from the scope of the invention.

Identical or functionally identical elements are provided with the same reference signs in the figures.

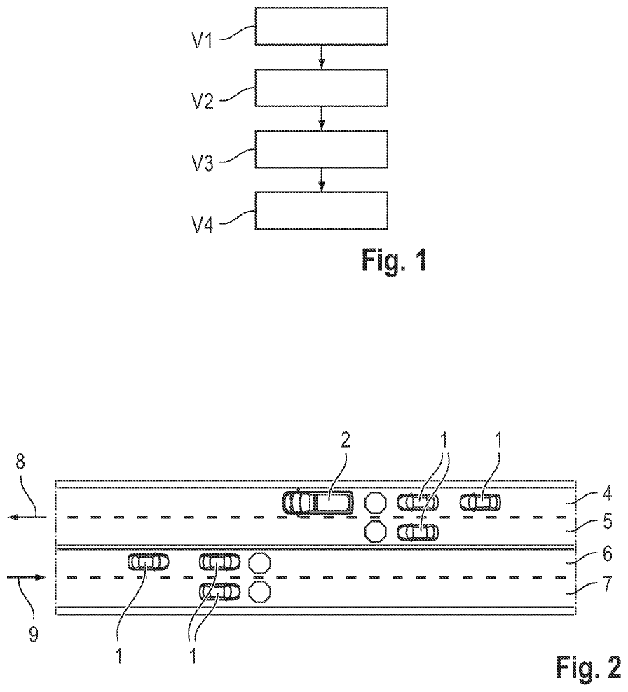

FIG. 1 shows a method diagram for a method for controlling a motor vehicle 1 by means of a driver assistance function. When controlling the motor vehicle 1, the driver of the motor vehicle 1 can be assisted by means of the driver assistance function. For this purpose, the longitudinal control and/or transverse control of the motor vehicle 1 can be at least influenced, in particular taken over, by the driver assistance function. In the method, it is provided that in a first method step V1, an object 2 in an environment of the motor vehicle 1 is determined based on camera data detected by means of a detection apparatus of the motor vehicle 1. For obtaining the camera data, the detection apparatus comprises a camera, which is directed at the environment of the motor vehicle, in particular pointing ahead in the travel direction starting from the motor vehicle 1.

In a second method step V2 of the method, the object 2 can be classified, in particular as a school bus, wherein in addition to the classification of the object 2, a confidence value 3 is determined, which characterizes the probability of the object 2 being a school bus. The object 2 can be determined and classified by image processing based on the camera data. Within the scope of the second method step V2, the object 2 is classified as a school bus if it is established that the object 2 has at least a preset minimum size and/or the object 2 is stopped at a passenger wait-area and/or a stop sign is arranged on the object 2 and/or multiple pedestrians are arranged at the lane edge within a preset maximum distance to the object 2 and/or a warning blinker of the object 2 is activated. The more these circumstances 11 are established as being present, the higher the confidence value 3 is determined. The respective circumstances 11 can be weighted differently with regard to their influence on the determination of the confidence value 3.

In a third method step V3 of the method, it is provided that the country in which the motor vehicle 1 is located is determined. In a fourth method step V4 of the method, it is provided that by means of the driver assistance function, an action of the motor vehicle 1 associated with the determined confidence value 3 is triggered, wherein the action is selected in dependence on the country in which the motor vehicle 1 is located. The method can be carried out by means of an electronic computing apparatus of the motor vehicle 1. As action, the motor vehicle 1 can be decelerated by means of the driver assistance function, in particular, up to a standstill of the motor vehicle 1. Alternatively or additionally, as action, an indicator signal that characterizes the determined object 2 classified as a school bus can be output in the interior of the motor vehicle 1. For different countries, with a traffic situation that is at least essentially the same, different actions of the motor vehicle 1 can be triggered by means of the driver assistance function. This enables particularly good compliance with country-specific requirements for how motor vehicles 1 should respond to school buses.

Depending on the determined amount of the confidence value 3, it can be provided that a type of the action triggered by the driver assistance function, or respectively, a magnitude of intervention of the action of the motor vehicle 1 triggered by the driver assistance system, depends on an act of the driver of the motor vehicle 1. This means that with a moderate determined confidence value 3, for example, as action, the motor vehicle 1 is slightly braked by means of the driver assistance function, however a complete braking of the motor vehicle 1 is not performed until it has been established that the driver has touched or actuated a brake pedal of the motor vehicle 1. The driver thus confirms the assessment of the driver assistance function that the object 2 is a school bus. As a consequence of the brake pedal having been determined to have been actuated, the driver assistance function triggers that the motor vehicle 1 is completely braked, and thus braked to a standstill, wherein the driver assistance function can control the motor vehicle 1 such that the motor vehicle 1 comes to a stop at a preset relative position to the object 2.

FIG. 2 shows a traffic situation with multiple motor vehicles 1 and an object 2 which is classified by the respective motor vehicles 1 as a school bus. As action, the motor vehicles 1 are stopped at respective preset relative positions to the object 2 by respective driver assistance systems associated with the motor vehicles 1 and are thus brought to a standstill. In this context, both those motor vehicles 1 located in the same lane as the object 2, as well as those motor vehicles 1 located in different lanes from the lane of the object 2, are stopped. In the present case, the road has four lanes, in particular a first lane 4, a second lane 5, a third lane 6 as well as a fourth lane 7. The object 2 is located in the first lane 4. Each of the first lane 4 and the second lane 5 both have a first travel direction 8. The third lane 6 and the fourth lane 7 each have a second travel direction 9 opposite to the first travel direction 8. The third lane 6 and the fourth lane 7 are thus each opposite-travel lanes relative to the first lane 4 and the second lane 5. In the present case, in the traffic situation shown in FIG. 2, the lanes are not structurally separated from one another. In the present case, it is provided for the country in which the traffic situation shown in FIG. 2 is playing out that when a school bus stops, all motor vehicles 1 on the same road must stop at preset relative positions to the school bus if they are within a preset distance to the school bus, unless a structural separator 10 of the lanes is present.

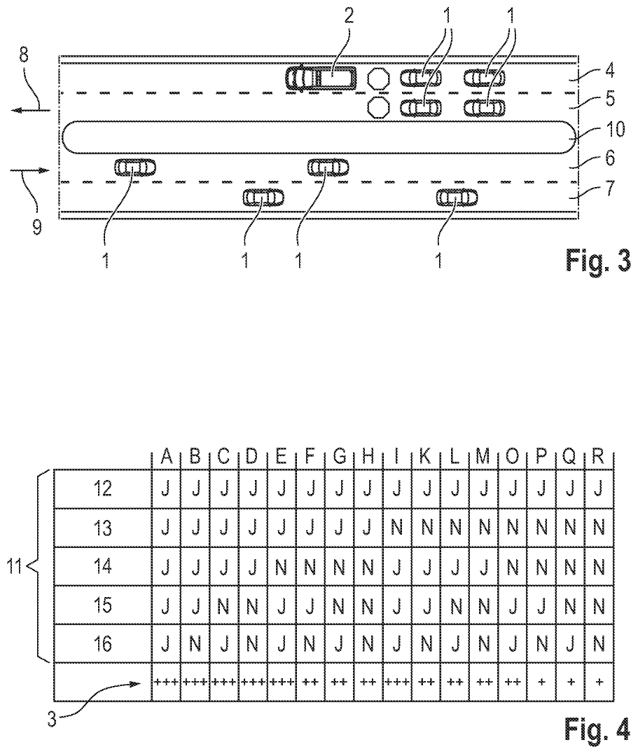

FIG. 3 shows a traffic situation for the same country in which the third lane 6 and the fourth lane 7 are separated from the first lane 4 and the second lane 5 by a structural separator 10. For the country in which the traffic situation shown in FIG. 3 takes place, it is provided that merely motor vehicles 1 located in the lanes that are not structurally separated from the lane of the school bus must stop at the respectively preset relative position to the school bus, if they are within the preset distance to the school bus. Motor vehicles 1 respectively driving in the respective opposite-travel lanes, the third lane 6 and the fourth lane 7 in the present case, can thus continue driving in their respective lanes without stopping, despite the object 2 classified as a school bus being arranged, in particular stopping, in the first lane 4.

Thus, within the scope of the method, it can be determined in which lanes the object 2 classified as a school bus, and the respective motor vehicle 1, are located. The triggering of the action is omitted if it is determined that the motor vehicle 1 is located in an additional lane that is structurally separated from the first lane 4 in which the object 2 classified as a school bus is located, the third lane 6 or the fourth lane 7 in the present case.

FIG. 4 shows an overview of determining the respective confidence value 3 for different cases A to R. In each of the cases A to R, it is investigated whether respective circumstances 11 are present. If the respective investigated circumstance 11 is present, then a “J” for yes should be entered in the table. If it is established that the respective circumstance 11 is not present, or respectively, if the presence of the respective circumstance 11 cannot be determined, then an “N” for no should be entered for this circumstance 11 in the table for the respective case. The confidence value 3 is determined in dependence on how many, or respectively, which, of the respective circumstances 11 are determined as present and thus are characterized with a “J” in the table. In this context, “+++” is entered for a high confidence value 3 of the respective case, “++” for a moderate confidence value 3 and “+” for a low confidence value 3. The first circumstance 12 investigated is whether a stopping large vehicle can be identified as object 2 in the environment of the motor vehicle 1, in particular based on the camera data. The second circumstance 13 checked is whether a so-called school zone or passenger wait-area at which the object 2 stops can be identified. The third circumstance 14 checked is whether a stop sign can be identified on the object 2. The fourth circumstance 15 checked is whether multiple pedestrians at the lane edge can be identified in the vicinity of the object 2, and thus within the preset maximum distance to the object 2. In particular, it is checked whether a number of pedestrians determined at the lane edge exceeds a preset limit value for the number of pedestrians. The fifth circumstance 16 checked is whether an activated warning blinker can be identified on the object 2.

The described method is based on the rationale that special consideration is to be given to buses in road traffic. When a bus stopped at a passenger wait-area puts on its blinker, an approaching vehicle is then no longer permitted to pass the bus. This is provided for to ensure a safe transition of the bus from the passenger wait-area to a lane. An approaching vehicle must brake or, as the case may be, stop.

Special rules of conduct apply in so-called school zones in the U.S. to ensure safe boarding and exiting of school children. These school zones serve the school buses for stopping, among other things. Speed limits of 20 mph, or respectively, 30 mph, usually apply in the school zones. School buses in the U.S. usually have two stop signs that can fold out. These can be well visible both for vehicles following behind the school bus as well as for vehicles in the opposite-travel lane approaching the school bus from the front. In the U.S., it is provided that when the school bus stops, both vehicles following behind the school bus as well as the vehicles approaching the school bus from the front are to stop. This also applies for most multi-lane roads. If lanes and opposite-travel lanes are structurally separated from one another, then solely the vehicles in the opposite-travel lane are not required to stop when the school bus stops.

The driver assistance function described in connection with the method enables an automatic response of the motor vehicle 1 to stopping buses and school buses, in particular an automatic stopping of the motor vehicle 1. The driver assistance system enables an automatic stopping of the motor vehicle 1 in compliance with country-specific rules of conduct. Alternatively or additionally to the stopping of the motor vehicle 1, as an action, a warning can be output to the driver if the driver violates country-specific rules of conduct. Reliable classification that the object 2, which in particular is a stopping vehicle, is actually a bus or school bus and not a car, is a challenge since the mentioned country-specific rules of conduct must only be complied with in interactions with school buses. Buses or school buses can be classified with the help of cameras. Image processing algorithms of the cameras can be trained for identifying and classifying school buses. Adapting image processing algorithms for classifying buses or school buses could be very expensive. This expense results from the fact that the appearance of buses and school buses is country-specific and therefore a large quantity of training data from many different countries would be required for training the image processing algorithms. In principle, buses or school buses can be equipped with Car-to-Car communication to share with other traffic participants that “I am a bus”, or respectively, “I am a school bus”. At the same time, they could share their intention to stop or drive ahead with the respective other traffic participants, such that the other traffic participants can respond in a timely manner thereto. Equipping all buses and school buses as well as other vehicles with Car-to-Car communication has currently not yet been achieved.

The method enables a particularly simple classification of an object 2 as a bus or school bus without an image processing algorithm trained specifically for classifying school buses and without Car-to-Car communication. In the method, stopping vehicles are identified with the help of environmental sensors. Using camera data, an image processing algorithm can classify stopping vehicles as “passenger car” and thus as a small vehicle or “truck” and thus as a large vehicle. In this context, a school bus could be primarily classified as “truck” and thus as a large vehicle. Stop signs arranged on the vehicle can be identified as such by the image processing algorithm. Furthermore, the image processing algorithm of the camera can classify objects at the lane edge as “pedestrians” and identify an active warning blinker of a vehicle. School zones and bus passenger wait-areas can be characterized as such in map data. By correlation of the mentioned data, a confidence value 3 that the identified large vehicle is a school bus can be increased. The more the circumstances mentioned in connection with FIG. 4, which in each case indicate a stopping bus or school bus, are present, the higher the associated confidence value 3 for the classification. The determined confidence value 3 for “bus/school bus identified” can be transferred to a driver assistance system. This can then suitably control other systems in the vehicle. For example in the U.S., with a high determined confidence value 3, the motor vehicle 1 can be automatically and conveniently braked to a standstill at a preset relative position to the stopping school bus. This can be implemented both with motor vehicles 1 in lanes with the same travel direction as the first lane 4, in which the object 2 is located, as well as for opposite-travel lanes. With a moderate determined confidence value 3, the driver is warned by means of the indicator signal and the motor vehicle 1 is slightly decelerated. If the driver actuates the brake pedal in this context, then the motor vehicle 1 is automatically braked to a standstill. With a lower determined confidence value 3, the driver is warned solely by output of the indicator signal and a decelerating of the motor vehicle 1 is omitted. For motor vehicles 1 in a structurally separated opposite-travel lane, no warning of the driver or decelerating of the motor vehicle 1 occurs regardless of the determined confidence value 3.

In Europe, for example, with a high determined confidence value 3, the motor vehicle 1 can no longer pass the bus with activated warning blinkers, but rather is automatically braked behind the bus, in particular to a preset relative position to the object 2. With a moderate determined confidence value 3, the driver is warned by output of the indicator signal and the motor vehicle 1 is slightly decelerated. If the driver actuates the brake pedal in this context, then the motor vehicle 1 is automatically braked to a standstill. With a lower determined confidence value 3, the driver is solely warned by output of the indicator signal, a decelerating of the motor vehicle 1 is omitted. Motor vehicles 1 in an opposite-travel lane to the lane in which the bus is located generally do not have to respond to the bus.

Overall the teachings herein show how a simple method for increasing confidence in the classification of buses and school buses can be implemented.

### LIST OF REFERENCE NUMERALS

1 Motor vehicle
2 Object
3 Confidence value
4 First lane
5 Second lane
6 Third lane
7 Fourth lane
8 First travel direction
9 Second travel direction
10 Separator
11 Circumstance
12 First circumstance
13 Second circumstance
14 Third circumstance
15 Fourth circumstance
16 Fifth circumstance
A to R respective cases

The invention has been described in the preceding using various exemplary embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, module or other unit or device may fulfil the functions of several items recited in the claims.

The term “exemplary” used throughout the specification means “serving as an example, instance, or exemplification” and does not mean “preferred” or “having advantages” over other embodiments. The term “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

1-10. (canceled)

11. A method for controlling a motor vehicle by a driver assistance function, comprising:
within an environment of the motor vehicle, determining an object which is classified as a school bus;
determining a confidence value for this classification using the driver assistance function; and
triggering an action of the motor vehicle associated with the determined confidence value, wherein the action is selected in dependence on the country in which the motor vehicle is located.

12. The method of claim 11, wherein it is determined what lanes the object classified as a school bus, and the motor vehicle, are located in and the triggering of the action is omitted if it is determined that compared to a first lane in which the object classified as a school bus is located, the motor vehicle is located in a second lane structurally separated from the first lane.

13. The method of claim 11, wherein, as action, the motor vehicle is decelerated using the driver assistance function, in particular the motor vehicle is automatically braked to a standstill at a preset relative position to the object, and/or an indicator signal characterizing the determined object classified as a school bus is output in the interior of the motor vehicle.

14. The method of claim 13, wherein if during deceleration of the motor vehicle using the driver assistance function, it is determined that a brake pedal of the motor vehicle has been actuated, the motor vehicle is automatically braked to a standstill using the driver assistance function.

15. The method of claim 14, wherein the object is determined and classified through image processing based on camera data detected using a detector of the motor vehicle.

16. The method of claim 14, wherein the object is classified as a school bus if at least one of the following circumstances is established:
the object is at least a preset minimum size,
the object stops at a passenger wait-area,
a stop sign is arranged on the object,
multiple pedestrians are arranged at the lane edge within a preset maximum distance to the object,
a warning blinker of the object is activated.

17. The method of claim 16, wherein the more the circumstances are established as being present, the higher the confidence value is determined.

18. The method of claim 17, wherein the circumstances are weighted differently with regard to their influence on the determination of the confidence value.

19. An electronic computing apparatus which is configured to:
within an environment of the motor vehicle, determine an object which is classified as a school bus;
determine a confidence value for this classification using the driver assistance function; and
trigger an action of the motor vehicle associated with the determined confidence value, wherein the action is selected in dependence on the country in which the motor vehicle is located.

20. A motor vehicle having an electronic computing apparatus of claim 19.

21. The method of claim 12, wherein, as action, the motor vehicle is decelerated using the driver assistance function, in particular the motor vehicle is automatically braked to a standstill at a preset relative position to the object, and/or an indicator signal characterizing the determined object classified as a school bus is output in the interior of the motor vehicle.

22. The method of claim 21, wherein if during deceleration of the motor vehicle using the driver assistance function, it is determined that a brake pedal of the motor vehicle has been actuated, the motor vehicle is automatically braked to a standstill using the driver assistance function.

23. The method of claim 22, wherein the object is determined and classified through image processing based on camera data detected using a detector of the motor vehicle.

24. The method of claim 22, wherein the object is classified as a school bus if at least one of the following circumstances is established:
the object is at least a preset minimum size,
the object stops at a passenger wait-area,
a stop sign is arranged on the object,
multiple pedestrians are arranged at the lane edge within a preset maximum distance to the object,
a warning blinker of the object is activated.

25. The method of claim 24, wherein the more the circumstances are established as being present, the higher the confidence value is determined.

26. The method of claim 25, wherein the circumstances are weighted differently with regard to their influence on the determination of the confidence value.
